(19) United States
(12) Patent Application Publication
(10) Pub. No.: US 2009/0273949 A1
(43) Pub. Date: Nov. 5, 2009

(54) Light guiding system for multiple areas

(76) Inventors: Steven Tseng, Taipei City (TW); Szu-Tsung Chang, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/149,282

(22) Filed: Apr. 30, 2008

(51) Int. Cl. F21V 8/00; F21V 11/00

(52) U.S. Cl. 362/613; 362/615

(57) ABSTRACT

A light guiding system for multiple areas is provided for a mobile communication device with a keypad module. The light guiding system includes a lighting source unit, a light guiding unit, and a control circuit unit. The lighting source unit has at least one light emitting member for generating a single lighting or a combined lighting. The control circuit unit is utilized for controlling the light emitting members of the lighting source unit to emit the single or combined lighting. The light guiding unit is provided for guiding the single or the combined lighting to a portion of or an entire area of the keypad module. Accordingly, the portion of the keypad module or the entire area of the keypad module is lit by the single/combined lighting. The different lighting areas of the keypad module provides a guiding effect that improves the using efficiency.

### BACKGROUND OF THE INVENTION

1. Field of the Invention

The present invention relates to a mobile communication device, and particularly relates to a mobile communication device having a light guiding system for multiple areas, which generates a single light or a combined light.

2. Description of Related Art

As technologies have developed, portable high-tech electronic devices, such as mobile communication devices, MP3/4 players, and digital cameras, have spread rapidly and broadly throughout society. Especially in the prior art of mobile communication devices, many of the devices, such as cell phones, Smart Phones, Personal Digital Assistants (PDAs), have become used regularly throughout people's daily lives. The light weight, portability, multiple functions and low price have made them popular, convenient and an indispensable part of modern life.

For displaying the content of a keypad module of a conventional mobile communication device, a backlight module with LEDs is usually employed under the keypad module. The rubber, a composite material of the keypad module, can scatter light from the backlight module so as to further distribute the light on the plane thereof and emit the light upward for lighting the symbols prearranged on the keypad module.

The backlight module of a conventional mobile communication device provides a single light source so that the entire plane of the keypad module is either lit or not. Pressing any key causes all of the LEDs to light. When too many LEDs light up, unnecessary spots are lit due to the small size of the keypad module. Unnecessarily lit spots confuse users when they are choosing keys. Obviously, creating individual sources for lighting multiple areas of the keypad module will improve the using efficiency.

Hence, an improvement over the prior art is required to overcome the disadvantages thereof.

### SUMMARY OF THE INVENTION

One aspect of the present invention is therefore to specify a light guiding system for multiple areas for a mobile communication device with a keypad module, which creates a single lighting or a combined lighting, which lighten a single area of the keyboard or the entire area. The different lighting areas of the keypad module provide a guiding effect and improve the using efficiency.

According to one embodiment of the present invention, the aspect is achieved by providing a light guiding system for multiple areas for a mobile communication device with a keypad module. The device includes a lighting source unit, a light guiding unit, and a control circuit unit. The lighting source unit is set in the mobile communication device and includes at least one light emitting member to create a single or a combined lighting, which lighten a single area or the entire keyboard module. The light guiding unit is disposed in the mobile communication device. The control circuit unit is arranged in the mobile communication device and electrically controls the lighting by the light emitting member.

The lighting is capable of illuminating a portion of or the entire area of the keypad module via the light guiding unit; and the combined lighting is capable of illuminating the entire area of the keypad module via the light guiding unit.

According to the present invention, one advantage of one embodiment of the present is the provision of the single lighting or the combined lighting via the control circuit unit and the illumination of the portion of or the entire area of the keypad module via the light guiding unit. This design will prevent the user from becoming confused when choosing keys as a result of there being too many unnecessary lighting spots. The different means of lighting the keypad module improves the variable guiding effect and makes the device easier to use.

To provide a further understanding of the present invention, the following detailed description illustrates embodiments and examples of the present invention. Examples of the more important features of the present invention have thus been summarized broadly in order that the detailed description thereof that follows may be better understood, and in order that the contributions to the art may be appreciated. There are, of course, additional features of the present invention that will be described hereinafter which will form the subject of the claims appended hereto.

### BRIEF DESCRIPTION OF THE DRAWINGS

These and other features, aspects, and advantages of the present invention will become better understood with regard to the following description, appended claims, and accompanying drawings, where:

FIG. 1 is a plan of a light guiding system for multiple areas according to a first embodiment of the present invention;

FIG. 2 is a partial decomposition view of the light guiding system for multiple areas according to the first embodiment of the present invention;

FIG. 3 is a perspective view illustrating a part of the light guiding system for multiple areas according to the first embodiment of the present invention;

FIG. 4 is a plan of a light guiding system for multiple areas according to a second embodiment of the present invention;

FIG. 5 is a partial decomposition view of the light guiding system for multiple areas according to the second embodiment of the present invention;

FIG. 6 is a perspective view illustrating partial of the light guiding system for multiple areas according to the second embodiment of the present invention;

FIG. 7 is a partial decomposition view of the light guiding system for multiple areas according to a third embodiment of the present invention;

FIG. 8 is a partial perspective view of the light guiding system for multiple areas according to the third embodiment of the present invention;

FIG. 9 is a partial perspective view of the light guiding system for multiple areas according to a fourth embodiment of the present invention; and

FIG. 10 is a partial decomposition view of the light guiding system for multiple areas according to a fifth embodiment of the present invention.

### DETAILED DESCRIPTION OF THE PREFERRED EMBODIMENTS

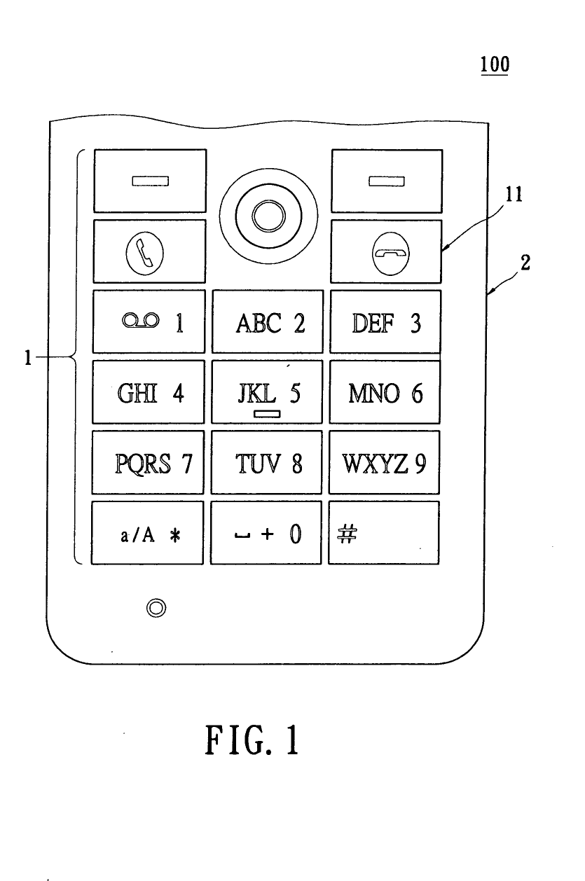

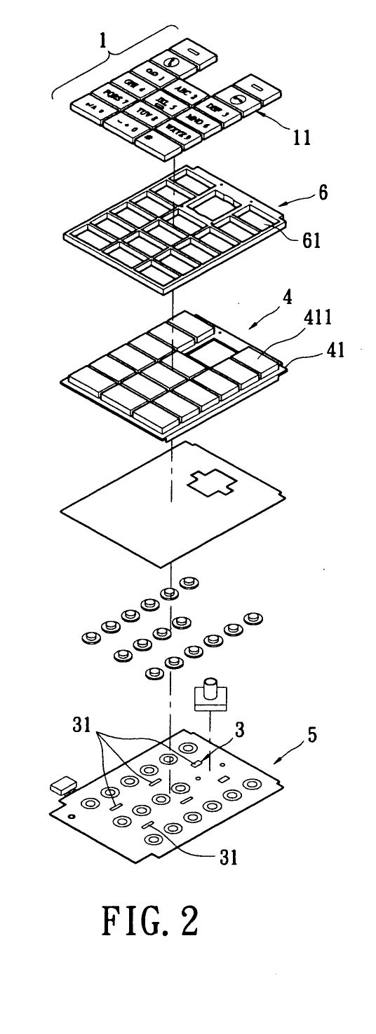

Please refer to FIGS. 1 and 2, which show a light guiding system for multiple areas of a mobile communication device 100 with a keypad module 1 according to one embodiment of the present invention. The light guiding system for multiple areas includes a lighting source unit 3, a light guiding unit 4, and a control circuit unit 5.

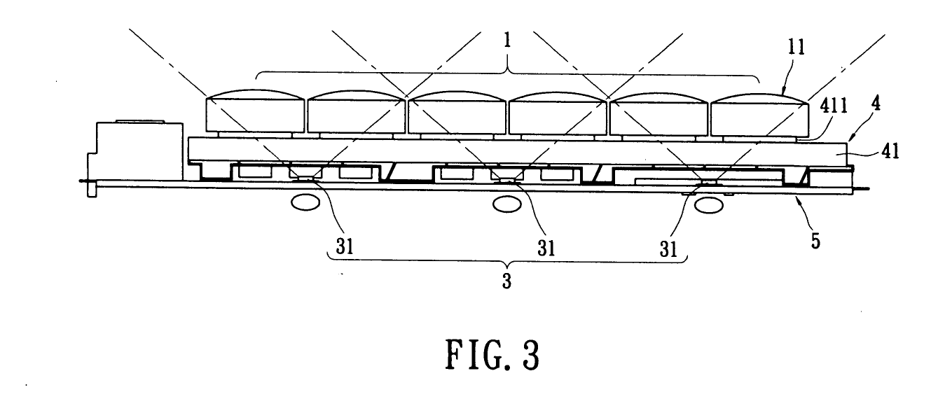

The mobile communication device 100 illustrated in FIGS. 1 to 3 is a cell phone, and further includes a casing 2. The control circuit unit 5, the lighting source unit 3, the light guiding unit 4, and the keypad module 1 are sequentially arranged in the casing 2 from bottom to top. In particular, the keypad module 1 usually includes two groups of keys 11. One group of keys consists of a plurality of buttons with text (such as English letters or/and phonetic notations) and numbers printed thereon, while the other group of keys consists of a plurality of buttons with predetermined functions (such as make/receive a call).

The mentioned control circuit unit 5 can be a printed circuit board. The lighting source unit 3 includes at least one light emitting member 31. According to this embodiment in FIGS. 1 to 3, the lighting source unit 3 includes a plurality of top-emitting Light Emitting Diodes (LEDs). The LEDs (light emitting members 31) are electrically connected to the printed circuit board (the control circuit unit 5) and arranged on the printed circuit board in rows.

The light guiding unit 4 includes a translucent light permeable buffering member 41, which permits light to pass therethrough. The translucent or transparent keys 11 of the keypad module 1 are also disposed in the light guiding unit 4. The light guiding unit 4 is made of rubber or another optical plastic material that allows light to pass therethrough. The mobile communication device 100 further includes a support member 6 arranged between the light permeable buffering member 41 and the keypad module 1. The support member 6 includes a plurality of cavities 61 that correspond in number to the keys 11. The light permeable buffering member 41 includes a plurality of protrusions 411 formed on a surface thereof that respectively relate to the cavities 61 of the support member 6. The protrusions 411 are flexible and light permeable. Each protrusion 411 is arranged in a respective one of the cavities 61 so as to correspond to a respective one of the keys 11. Because the keys 11 are orientated with the corresponding cavities 61 and protrusions 411, the light guiding unit 4 is arranged in accordance with the lighting source unit 3. The light emitting members 31 are programmable and electrically controlled by the printed circuit board. Some of the light emitting member 31 can emit light to provide a single lighting, or all of the light emitting member 31 emit light to provide a combined lighting. The light emitting members 31 can emit blue light or white light; alternatively, the light emitting members 31 can emit the same color of light.

When any one of the keys 11 of the keypad module 1 is pressed, the light emitting members 31 controlled by the printed circuit board produce a top-emitting light. The light passes upwardly via the protrusions 411 of the light permeable buffering member 41, and illuminates outward via the keys 11 of the keypad module 1 in order to light the symbols (English letters, phonetic notations or predetermined functions) on the keys 11.

Furthermore, the light emitting members 31 according to this embodiment are divided into several colors of light; for example, some of the light emitting members 31 emit a blue light, and some emit a white light. After a respective one of the keys 11 (such as a make/receive call button) is pressed, the white-color light emitting members 31 light up. The blue-color light emitting members 31 are programmed to light up by proceeding the white-color light emitting members 31, so that a combined lighting is produced. At the same time, the keys 11 will light up and the entire area of the keypad module 1 is lit up thereby. In another way, after another one of the keys 11 (such as a text character combined with a number button) is pressed, only the blue-color light emitting members 31 light up. The white-color light emitting members 31 are designed to stop emitting light, and the single lighting is produced thereby. The single lighting is spread over the entire area of the keypad module 1. Alternatively, the single lighting can be designed to illuminate the pressed key 11 (meaning the portion of the keypad module 1) for providing a guiding effect.

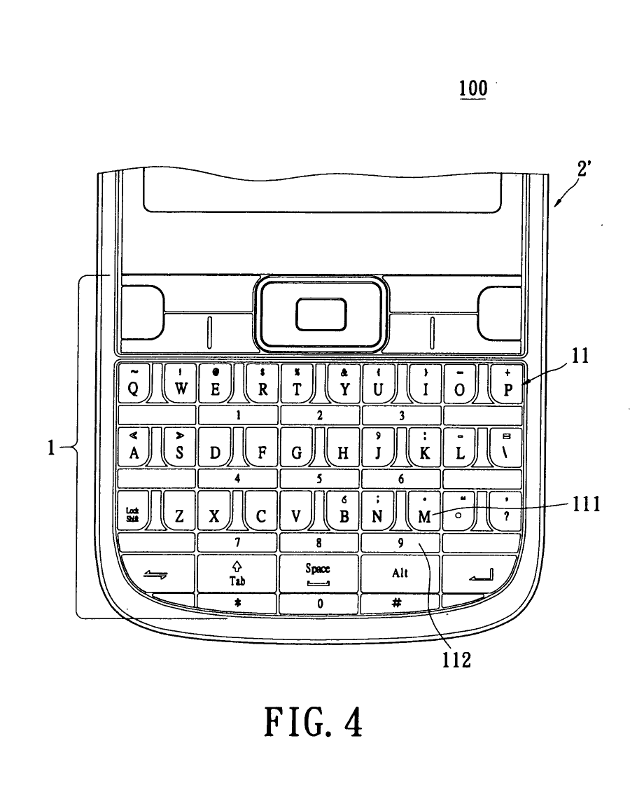

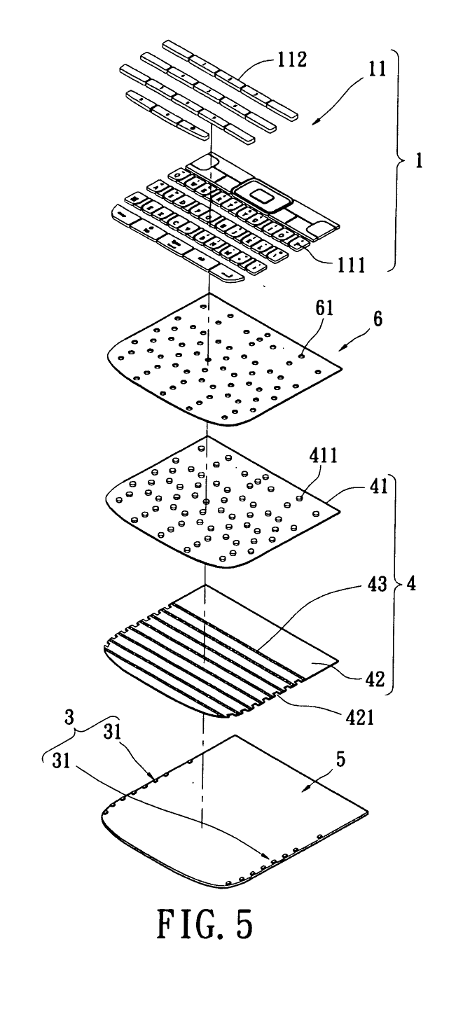

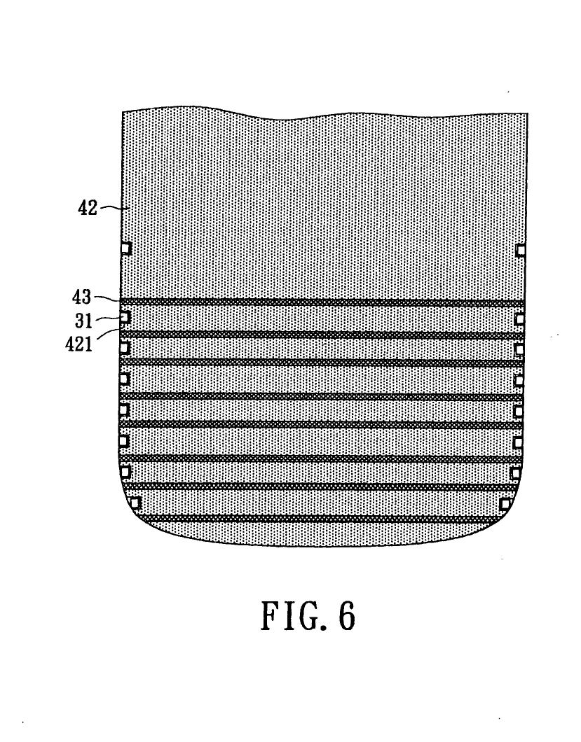

With respect to FIGS. 4 to 6, the mobile communication device 100 is a Smart Phone. The mobile communication device 100 includes a casing 2′. The control circuit unit 5, the lighting source unit 3, light guiding unit 4, and the keypad module 1 are sequentially arranged on the casing 2 from bottom to top. The keypad module 1 includes at least two groups of keys 11. For example, one group of keys consists of text buttons 111 (such as English letters or/and phonetic notations), and the number buttons 112. Another group of keys of the keypad module 1 consists of functional buttons (such as making/receiving calls or controlling a cursor on the display).

The light emitting members 31 of the lighting source unit 3 produce an edge-emitting light and are arranged on the lateral edges of the printed circuit board. The light guiding unit 4 illustrated in this embodiment further includes a light permeable polyester film 42, a plurality of light-stopping ribs 43 embedded in the light permeable polyester film 42 and disposed in parallel with one another. The light permeable polyester film 42 is an optical member and permits light pass therethrough. The light permeable polyester film 42 has a plurality of recesses 421 formed on lateral fringes thereof.

The mobile communication device 100 further includes a light permeable buffering member 41 and a support member 6. The support member 6 includes a plurality of cavities 61 that correspond in number to the keys 11. The light permeable buffering member 41 includes a plurality of protrusions 411 formed on a surface thereof that respectively relate to the cavities 61 of the support member 6. Each protrusion 411 is arranged in a respective one of the cavities 6 so as to correspond to a respective one of the keys 11. The keys 11 are orientated on the corresponding cavities 61 and protrusions 411.

The light permeable polyester film 42 and the light-stopping ribs 43 are arranged under the light permeable buffering member 41. The keypad module 1 corresponds to the light guiding unit 4 so that the text buttons 111 and the number buttons 112 of the keys 11 are arranged between each two adjacent light-stopping ribs 43. The light emitting members 31 are arranged between each two adjacent light-stopping ribs 43, and the light emitting members 31 are set in the recesses 421 of the light permeable polyester film 42 respectively.

The light emitting members 31 project edge-emitting light, which is transmitted into the light permeable polyester film 42 directly and emits light upward via the light permeable polyester film 42. The light is delivered outward via the protrusions 411 of the light permeable buffering member 41 and the keys 11 of the keypad module 1 sequentially. The text buttons 111 and the number buttons 112 are lit thereby. Each two adjacent light-stopping ribs 43 provide a closed portion that restrains the light therein and prevents the light from leaking to another portion or the entire area of the keypad module 1.

For example, the light emitting members 31 can emit blue light and white light. When the text buttons 111 are pressed, the white-color light emitting members 31 light up and the blue-color light emitting members 31 are programmed to light up by proceeding the white-color light emitting members 31. The combined lighting is provided to illuminate a portion or the entire area of the keypad module 1 (all of the keys 11). In another way, after the text buttons 111 are pressed, only the text buttons 111 are lit. The number buttons 112 are programmed to stop emitting light. The light restrained in each closed portion will not interfere with other lights, and is controlled by the control circuit unit 5. Due to the closed portion surrounded by the light-stopping ribs 43, the text buttons 111 and the number buttons 112 are independent from each other.

If the number buttons 112 are pressed, the blue-color light emitting members 31 lights up. The white-color light emitting members 31 do not light so that a single lighting is produced. The single lighting can spread over all of the number buttons 112 of the keypad module 1 for when a user is dialing a number, or the single lighting can light up partial portions (rows) of number buttons 112 for create individual lighting portions.

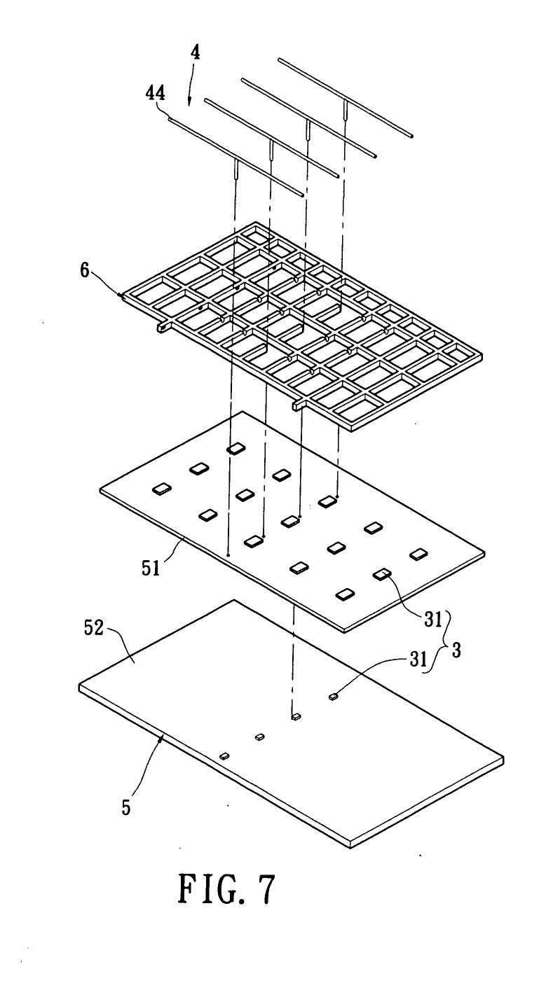

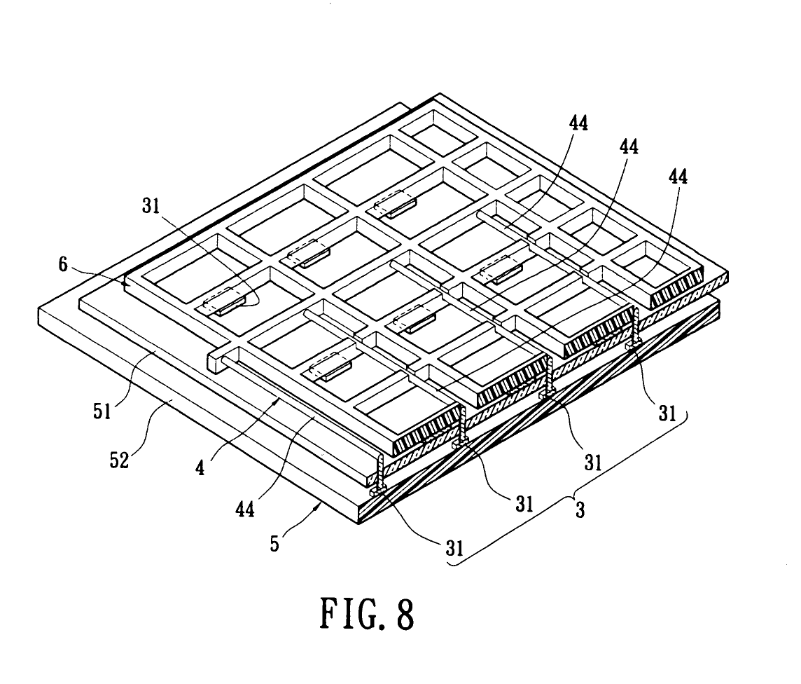

With respect to FIGS. 7 and 8 and further referring to FIG. 4, the light guiding unit 4 of the Smart Phone according to another embodiment of the present invention includes a plurality of light guiding pipes 44. The quantity of the light guiding pipes 44 is 4. Each of the light guiding pipes 44 is T-shaped and is an optical member that conducts light. The control circuit unit 5 includes an upper printed circuit board 51 and a lower printed circuit board 52. The light emitting members 31 of the lighting source unit 3 are Light Emitting Diodes (LEDs), and are divided into main lights and secondary lights. The main-lighting LEDs 31 are arranged in rows on an upper surface of the upper printed circuit board 51 of the control circuit unit 5 and under a framed support member 6. The secondary-lighting LEDs 31 are arranged on an upper surface of the lower printed circuit board 52 of the control circuit unit 5 and are disposed under the upper printed circuit board 51.

Each of the light guiding pipes 44 is embedded parallel to the support member 6. Each of the T-shaped light guiding pipes 44 includes a lower end at a vertical portion thereof. The lower end of each light guiding pipe 44 corresponds to a respective one of the secondary-lighting LEDs 31 by the upper printed circuit board 51 of the control circuit unit 5. Each of the light guiding pipes 44 has a horizontal portion that corresponds to a respective one of the independent keys 11, such as a respective set of number buttons 112. Accordingly, there are four sets of independent number buttons 112 that correspond to the four light guiding pipes 44 for independently providing light. Except for the four top-emitting, secondary-lighting LEDs 31, the other LEDs serve as the main-lighting LEDs 31.

If any one of the text buttons 111 is pressed, the entire main-lighting LEDs 31 light up so as to provide the single lighting. The single lighting can illuminate the entire keys 11 (including the text buttons 111, the number buttons 112, and the dial button). At this time, the secondary-lighting LEDs 31 emit light or stop emitting light in a simultaneous manner. If the secondary-lighting LEDs 31 emit light simultaneously, the combined lighting mixed with the main lighting and the secondary lighting is produced. In another way, if any of the number buttons 112 are pressed, the secondary-lighting LEDs 31 lights up simultaneously is taken as/to produce a single lighting. The single lighting is projected and transmitted via the light guiding pipes 44 to light up the number buttons 112. In the meantime, the main-lighting LEDs 31 don't light up, meaning other keys 11 (text buttons 111) will also not light up. Moreover, because the secondary-lighting LEDs 31 are arranged on the upper surface of the lower printed circuit board 52 of the control circuit unit 5 and under the upper printed circuit board 51, the light from the secondary-lighting LEDs 31 spreads outwardly only via the light guiding pipes 44.

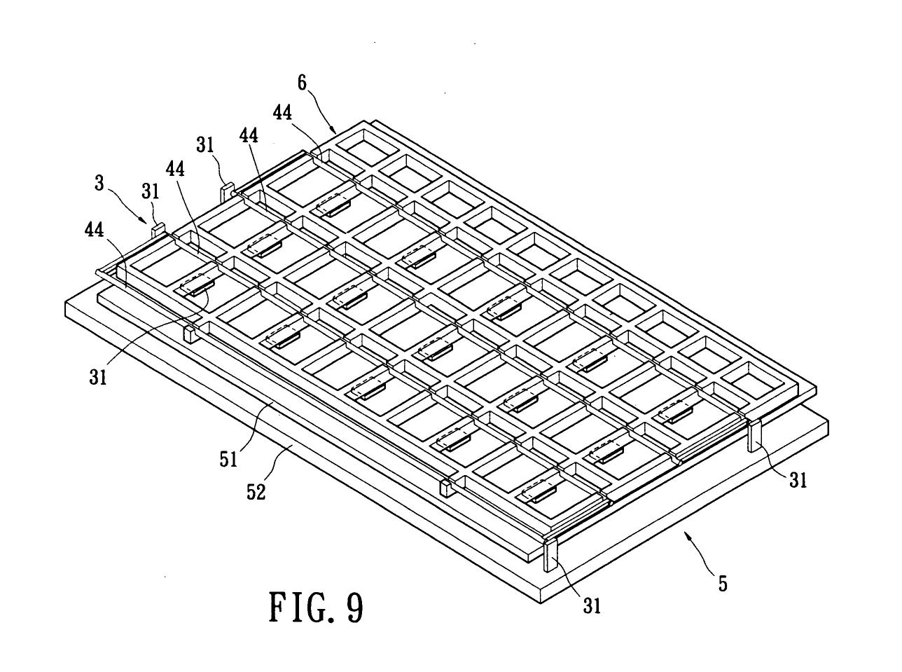

With respect to FIG. 9 and further referring to FIG. 4, the configuration of each light guiding pipe 44 illustrated in this embodiment of the present invention varies. Each light guiding pipe 44 extends out of the opposite ends of the support member 6 so that the configuration of each light guiding pipe 44 is approximately shaped like a straight line. On end of each light guiding pipe 44 is adjacent to a respective edge-emitting, secondary-lighting LED 31. The edge-emitting, secondary-lighting LEDs 31 are arranged on the lateral fringes of the lower printed circuit board 52. The secondary lighting lights up the number buttons 112.

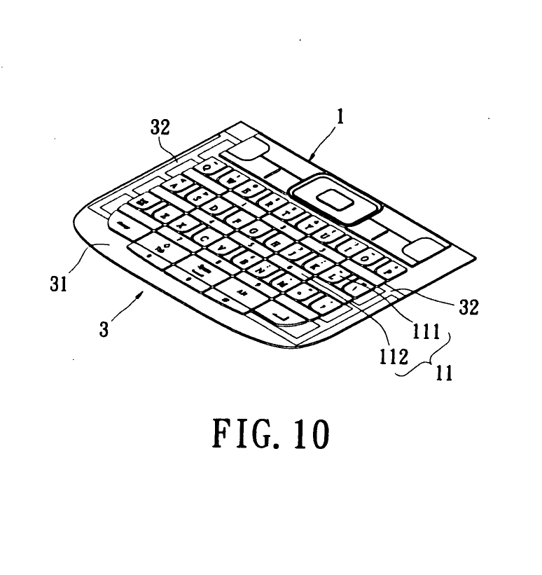

With respect to FIG. 10 and further referring to FIG. 4, the lighting source unit 3, the light guiding unit 4, and the keypad module 1 are made in an integral design. The light emitting member 31 is an electroluminescent film (EL film). The symbols on the keys are divided into at least two groups and are directly printed on the EL film 31. Therefore, the text buttons 111 and the number buttons 112 and other types of keys 11 are independent from each other. The light emitting member 31 further has at least two groups of the control circuits 32 for electrically connecting with the printed circuit board (not shown). The keys 11 are made of light permeable materials, for combining with the EL film 31 to be taken as the light guiding unit 4.

When any of the keys 11 are pressed, the EL film 31 projects light and the keys 11 conduct the light upward for illuminating the text buttons 111 and the number buttons 112. If any of the text buttons 111 are pressed, the EL film 31 lights up via a predetermined program controlled by the control circuit unit 5. The light from the EL film 31 spreads over all of the text buttons 111 and other keys 11 via the control circuits 32 to illuminate the keyboard. At the same time, the printed circuit board can command all the number buttons 112 to light up so that the combined lighting is provided. Because of the combined lighting, the entire area of the keypad module 1 thereby is lit up. In another example, all of the number buttons 112 are not lit up so that the single lighting illuminates only a portion of the keypad module 1 (the text buttons 111 and dial button).

In one example, if any of the number buttons 112 are pressed, the EL film 31 lights up the number buttons 112 via programming control. The text buttons 111 are controlled to not emit light. Thus, the single lighting is provided, and only a portion of the keypad module 1 (the number buttons 112) is lit up.

The light emitting member 31 controlled by the control circuit unit 5 provides the single lighting or the combined lighting. The single or combined lighting adapted for various configurations of the light guiding unit 4 can illuminate a portion or the entire area of the keypad module 1 so as to prevent unnecessarily lit spots. Furthermore, the keys 11 are divided into several groups for corresponding to the single lighting or the combined lighting to provide a guiding effect. For example, when the number buttons 112 are pressed, the number buttons 112, but not the text buttons 111, light up. This makes it easier for users to dial numbers so the using efficiency of the keyboard module is improved.

It should be apparent to those skilled in the art that the above description is only illustrative of specific embodiments and examples of the present invention. The present invention should therefore cover various modifications and variations made to the herein-described structure and operations of the present invention, provided they fall within the scope of the present invention as defined in the following appended claims.

What is claimed is:

1. A light guiding system for multiple areas of a mobile communication device with a keypad module, comprising:
a lighting source unit set in the mobile communication device and including at least one light emitting member for creating a single lighting or a combined lighting;
a light guiding unit disposed in the mobile communication device; and
a control circuit unit arranged in the mobile communication device and electrically controlling the single lighting or the combined lighting by the light emitting member;
wherein the single lighting is capable of illuminating a portion of or an entire area of the keypad module via the light guiding unit; and the combined lighting is capable of illuminating the entire area of the keypad module via the light guiding unit.

2. The light guiding system for multiple areas as claimed in claim 1, wherein the keypad module includes at least two groups of keys relating to the single or/and combined lighting.

3. The light guiding system for multiple areas as claimed in claim 2, wherein the light guiding unit includes a plurality of light guiding pipes; the light guiding pipes correspond to respective light emitting members to individually light the single lightings, and correspond to respective groups of the keys.

4. The light guiding system for multiple areas as claimed in claim 2, wherein the light emitting member is an electroluminescent film (EL film), the keys being made of light permeable materials that act as the light guiding unit; the EL film has at least two groups of symbols corresponding to the keys formed thereon and at least two control circuits corresponding to the two groups of symbols for forming an electrical connection with the control circuit unit.

5. The light guiding system for multiple areas as claimed in claim 1, wherein the light guiding unit includes a light permeable buffering member, which permits light to pass therethrough; wherein the single or combined lighting from the lighting source unit is guided upward to the keys of the keypad module for emitting light outward.

6. The light guiding system for multiple areas as claimed in claim 1, wherein the keypad module includes keys made of light permeable for guiding the single or combined lighting of the lighting source unit for emitting light outward.

7. The light guiding system for multiple areas as claimed in claim 1, wherein the light guiding unit includes:
a light permeable polyester film having two lateral sides corresponding to the plurality of light emitting members; and
a plurality of light-stopping ribs embedded in the light permeable polyester film in parallel with one another;
wherein the keypad module includes a plurality of groups of keys arranged between each two of the light-stopping ribs, each light emitting member being disposed on lateral sides between each two of the light-stopping ribs;
whereby the light from each light emitting member is emitted into a respective portion of the light permeable polyester film and delivered/guided to the corresponding keys thereby for emitting light outward.
